(19) United States
(12) Patent Application Publication
(10) Pub. No.: US 2006/0049091 A1
(43) Pub. Date: Mar. 9, 2006

(54) Reactive adsorbent for heavy elements

(76) Inventors: Jeffrey K. Cheetham, North Canton, OH (US); James Farrell, Tucson, AZ (US); Robert M. Wolfe, Massillon, OH (US); Abid Bengali, Naperville, IL (US)

Correspondence Address: DAVID P DURESKA;BUCKINGHAM DOOLITTLE & BURROUGHS, LLP, 4518 FULTON DRIVE, NW, P O BOX 35548, CANTON, OH, 44735-5548, US

(21) Appl. No.: 11/219,272

(22) Filed: Sep. 2, 2005

Related U.S. Application Data
(60) Provisional application No. 60/606,993, filed on Sep. 3, 2004.

(51) Int. Cl. C02F 1/28; C02F 1/62

(52) U.S. Cl. 210/283; 210/284

(57) ABSTRACT

An adsorbent is disclosed which uses an iron-containing metal oxide as an adsorbent for removing heavy elements from contaminated waters and method for the use of the same. The bed includes a non-stoichiometric ferrous oxide Fe₁₋ₓO, which is structurally in a Wustite crystal phase form having the rock salt, face-centered cubic lattice.

### CROSS-REFERENCE TO RELATED APPLICATION

This application claims the benefit of U.S. Provisional Application Ser. No. 60/606,993, filed on Sep. 3, 2004.

### GOVERNMENT RIGHTS

The U.S. Government has a paid-up license in this invention and may have the right in limited circumstances to require the patent owner to license others on reasonable terms as provided for by the terms of Grant No. 2P42ES04940-11 awarded by the National Institute for Environmental Health Sciences.

### TECHNICAL FIELD

This invention relates generally to a method and a composition for removing heavy elements, including arsenic from contaminated aqueous streams. More particularly, the present invention is directed toward the use of an iron-containing metal oxide as an adsorbent for heavy elements. More particularly, the present invention is directed toward a method of passing heavy element contaminated waters through a compact bed comprised of a non-stoichiometric ferrous oxide, e.g., Fe₁₋ₓO, at least a portion of which is structurally in a Wustite crystal phase form, having the rock salt, face-centered cubic lattice, wherein x is in a range of from about 0.023 to about 0.14. The chemistry and the structure of the adsorbent media particles is designed to efficiently remove heavy elements from the water while maximizing the life of the bed.

### BACKGROUND OF THE INVENTION

Water contaminated with heavy elements may be encountered in many different locations including, without limitation, effluent from mining and mineral processing activities, in waste ash from coal fired power plants, in wells in the vicinity of such operations, and in naturally occurring sources. As ground waters become increasingly contaminated with heavy elements, and the U.S. Environmental Protection Agency's acceptable threshold limits for these heavy elements, particularly arsenic decrease, new methods for inexpensive contaminant removal are needed since existing methodologies are inadequate to meet such requirements. In fact, in recent years, emphasis on discharging clean water into rivers, bays, and the like has increased dramatically.

In order to protect against such water contamination, it is necessary to select treatment methods for effluent from activities producing the contaminated water before it can find its way into groundwater, wells or other water supplies. It is also necessary to select treatment methods for contaminated water which has already found its way into groundwater, wells or other water supplies.

Removal of certain heavy elements including arsenic, from contaminated water by the addition of iron-containing compounds are well known in the prior art. These methods generally co-precipitate the iron with arsenic as insoluble precipitates and separate the precipitates from the water. However, the success of such methods is strongly dependent on the condition of the contaminated water before it is treated. In most cases, the success of a particular method will be adversely affected by the presence of competing ions.

While the addition of an oxidizing agent to heavy metal-impacted drinking water may cause precipitation of the insoluble heavy element, thereby treating the water, the process does not necessarily work for arsenic-impacted water. For example, an oxidizing agent may be added to iron-impacted drinking water to precipitate out the iron. When used for arsenic-impacted water, however, the process results in ineffective or unacceptable levels of treatment. It is recognized that arsenic is but one example, and that this problem extends to many other heavy elements.

Certain heavy element compounds, e.g., arsenic compounds, are also known to form strong chemical adsorption complexes with a wide range of trivalent iron oxides. The binding involves complex formation with ferric oxides and hydroxides. Given the rapid surface complex formation, the slow approach to sorptive equilibrium, often requiring hours or days to reach, has been attributed to the slow diffusion of arsenic or other heavy element species through porous iron oxides.

The strong binding of arsenic compounds to iron oxides has promoted the development of granular ferric oxides (GFO) as for example, an adsorbent media for arsenic removal. Since complex formation of arsenic species with iron oxides is known to be extremely rapid, the removal process is usually limited by diffusion of arsenic species through the porous iron oxides to available adsorption sites. The main drawback to GFO media is that the material is thermodynamically unstable and ages to form more stable oxides with lower surface areas and decreased porosities. The aging of the GFO media during use leads to increasing mass transfer limitations with elapsed time. This often leads to early arsenic breakthrough, and the bed must be retired before a significant fraction of its capacity can be utilized.

Another iron-containing material that is used for arsenic removal is zero valent iron (ZVI). Under conditions applicable to drinking water treatment, removal by zero valent iron media involves surface complexation only, and does not involve reduction. Corrosion of ZVI results in the continuous generation of iron oxides at the surfaces of the iron filings. The iron oxides serve as sites for chemisorption of both As(V) and As(III) compounds. Because the iron oxides are continuously generated, mass transfer limitations associated with the loss of surface area and porosity as the oxides age are less than those associated with ferric iron-based media. However, the major problem with zero valent iron as an adsorption media for arsenic removal is that its rate of corrosion is much greater than needed for generating iron oxide adsorption sites. Once formed, the oxides begin aging and lose surface area and porosity with time, and contribute to mass transfer limitations for arsenic removal which is undesirable.

The present invention solves the above-noted problems by providing an adsorbent for removal of heavy elements, including arsenic from contaminated water. This adsorbent can be used in a compact bed or as a batch additive wherein the adsorbent is comprised in part as particles of a non-stoichiometric ferrous oxide Fe₁₋ₓO, which is structurally in a Wustite crystal phase form having the rock salt, face-centered cubic lattice. The adsorbent particles are easy to use, relatively inexpensive to manufacture and durable enough to withstand repeated loadings of heavy-element contaminated water. More particularly, the divalent iron oxide particles contained within the bed function as a reactive adsorbent that continually generates trivalent iron oxide adsorption sites for arsenic and other heavy element removal at a controlled rate that is less than the rate of transition of zero valent iron oxide to trivalent iron oxide. These kinetics extend the useful life of the adsorbent by providing optimal use of the available iron species which is formed at a rate which more closely approximates the exposure rate of the contaminant, thereby extending the useful life of the bed.

### SUMMARY OF THE INVENTION

Accordingly it is a principal object of the invention to provide an adsorbent for removing arsenic and other heavy elements from contaminated water, which results in a relatively high level of remediation.

A further objective of the present invention is to provide a compact bed that, because of its composition of a non-stoichiometric ferrous oxide Fe₁₋ₓO, which is structurally in a Wustite crystal phase form having the rock salt, face-centered cubic lattice and, more particularly, wherein the divalent iron oxide particles are capable of continually generating trivalent iron oxide absorption sites at a controlled rate that is less than the rate of transition of zero-valent iron oxide to trivalent iron oxide, is capable of withstanding multiple loadings of heavy element (e.g., arsenic) contaminated water and has a longer useful life than those beds currently known in the art.

Yet another objective of the present invention is to provide a compact bed comprised in part of a non-stoichiometric ferrous oxide Fe₁₋ₓO, which is structurally in a Wustite crystal phase form having the rock salt, face-centered cubic lattice that is durable, easy to use and relatively inexpensive to manufacture.

Still another objective of the present invention is to provide an improved compact bed comprised of a non-stoichiometric ferrous oxide Fe₁₋ₓO, which is structurally in a Wustite crystal phase form having the rock salt, face-centered cubic lattice such as to eliminate or reduce the problems associated with the bed clogging prematurely.

These objectives and advantages are obtained by the method of removing heavy elements, (e.g., arsenic) from contaminated water by the present invention, the general nature of which may be stated as including the steps of: providing a compact bed comprised of adsorbent, wherein said adsorbent further comprises a non-stoichiometric ferrous oxide Fe₁₋ₓO, which is structurally in a Wustite crystal phase form having the rock salt, face-centered cubic lattice, the divalent iron oxide particles generating trivalent iron oxide absorption sites for heavy element (e.g., arsenic) removal at a controlled rate; and passing the contaminated water through the bed to remove the heavy element(s).

These and other objects of the present invention will become more readily apparent from a reading of the following detailed description taken in conjunction with the accompanying drawings and with further reference to the appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 shows arsenic removal concentrations over time in a static arsenic contaminant exposure test for three adsorbents;

FIG. 2 shows arsenic concentrations in the column effluent normalized by the influent concentrations of 50 μg-As/L and a mean hydraulic detention time in each column of 10 minutes for the oxygen saturated experiments;

FIG. 3 shows iron concentrations in the effluent water for columns with effluent arsenic concentrations shown in FIG. 2;

FIG. 4 shows arsenic concentrations in the column effluent normalized by the influent concentration of 50 μg-As/L and a mean hydraulic detention time in each column of 10 minutes for the low oxygen experiments;

FIG. 5 shows iron concentrations in the effluent water for columns with effluent arsenic concentrations shown in FIG. 4;

FIG. 6 shows arsenic concentrations in the column effluent normalized by the influent concentration of 50 μg-As/L and a mean hydraulic detention time in each column of 10 minutes for the deoxygenated water experiments; and

FIG. 7 shows iron concentrations in the effluent water for columns with effluent arsenic concentrations shown in FIG. 6.

### DETAILED DESCRIPTION OF THE INVENTION

Referring now to the drawings wherein the showings are for purposes of illustrating the preferred embodiment of the invention only and not for purposes of limiting the same, the Figures show contaminant removal performance using various non-limiting and exemplary compositions of the adsorbents used in the practice of this invention, specifically targeted toward the removal of arsenic, although it is recognized that other heavy-elements are equally applicable in this invention.

While not being held to any one theory of operation, it is believed that at least one reason for the excellent performance of the adsorbent according to the invention is attributable at least in part, to the fact that the main phase of the inventive adsorbent is a non-stoichiometric ferrous oxide Fe₁₋ₓO, which exists with favorable surface structure, and distribution of lattice defects including vacancy clusters. It is believed that the presence of defect clusters containing vacancies is an important factor in the atomic mobility within the lattice structure. It is also known that the diffusivity of vacancy defects is many times greater than atomic diffusivity. The atomic diffusivity is directly related to the movement of iron ions in the lattice.

One distinctive advantage of the invention stems from the fact that the content of oxygen in Wustite, expressed as Fe₁₋ₓO of the adsorbent is only about 22-24% by weight. It is also known that Wustite represented as Fe₁₋ₓO is understood to consist of Fe(III) in tetrahedral positions and Fe(II) existing at octahedral sites with surrounding vacancy clusters to maintain charge neutrality. It is also known that Wustite is metastable below 562° C. The Wustite retains two substructures at room temperature known as P′ and P″. The P′ substructure is represented by high symmetry and well-ordered structure with low non-stoichiometry. The P″ substructure is represented by low symmetry and high non-stoichiometry. Such Wustite is produced by the rapid quenching of molten iron oxide baths and is the focus of this invention. In the melting process used to manufacture the adsorbent according to this invention, the Fe(II)/Fe(III) ratio is in the range of from about 2 to about 20 which gives a wide range of operation flexibility.

The method of removing heavy elements from heavy element contaminated water of the present invention is believed to be accomplished by passing heavy elements contaminated water through a bed comprised in part of Wustite, wherein said Wustite further comprises a percentage of divalent iron oxide particles. Corrosion of divalent iron-containing oxides has the advantage of continuously generating high surface area iron oxides, but avoids the excessive oxide generation associated with zero valent iron oxide particles in the prior art. In waters containing even very low levels of dissolved oxygen, corrosion of divalent iron oxides is mass transfer limited and is controlled by the outward diffusion of Fe(II) atoms. In waters containing trace levels of dissolved oxygen, the oxidation rate of divalent iron bearing oxides is fast enough to generate iron oxide adsorption sites for removing micromolar levels of heavy element compounds, but slow enough to prevent the buildup of excessive oxides whose aging results in mass transfer limitations for heavy element(s) removal. More specifically, the rate of oxide buildup on mixed valent oxides is relatively slower than that for zero valent iron.

The method of removing arsenic from arsenic contaminated water of the present invention is believed to be accomplished by passing arsenic contaminated water through a bed comprised in part of Wustite, wherein said Wustite further comprises a percentage of divalent iron oxide particles. Corrosion of divalent iron containing oxides has the advantage of continuously generating high surface area iron oxides, but avoids the excessive oxide generation associated with zero valent iron oxide particles in the prior art. In waters containing even very low levels of dissolved oxygen, corrosion of divalent iron oxides is mass transfer limited and is controlled by the outward diffusion of Fe⁺⁺ atoms. In waters containing trace levels of dissolved oxygen the oxidation rate of divalent iron bearing oxides is fast enough to generate trivalent iron oxide adsorption sites for removing micromolar levels of arsenic compounds, but slow enough to prevent the buildup of excessive oxides whose aging results in mass transfer limitations for arsenic removal. More specifically, the rate of oxide buildup on mixed valent oxides is relatively slower than that for zero valent iron.

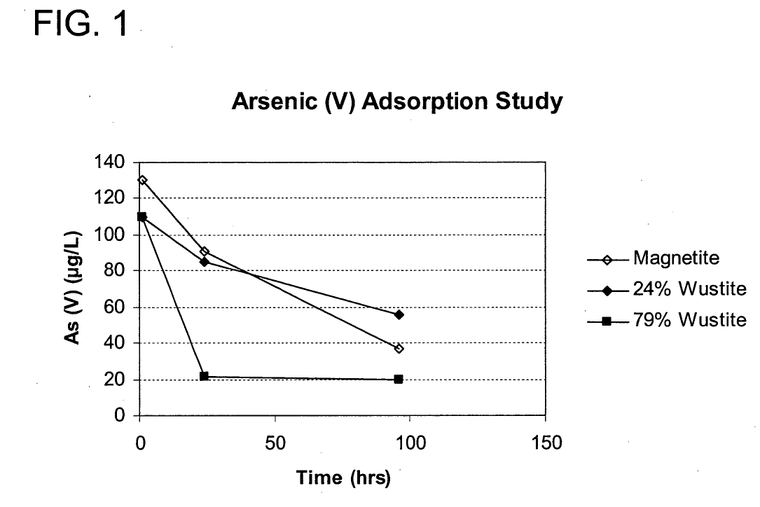

FIG. 1 and associated Table 1 illustrate one aspect of this invention. Standard arsenic solutions (As⁺⁵) at a contaminant level of 150 micrograms/L were prepared for testing in 3 media formulations mixed at a constant 5 gram media to 100 mL ratio and the media continuously exposed to the contaminated solution for the exposure times indicated. As⁺⁵ readings were taken at the designated times and the results illustrated in Table 2.

TABLE 1
Static Exposure Testing

| Exposure (hrs) | Magnetite | | 24% Wustite | | 79% Wustite | |
|---|---|---|---|---|---|---|
| 1 | 130 | μg/L | 110 | μg/L | 110 | μg/L |
| 24 | 91 | μg/L | 85 | μg/L | 21 | μg/L |
| 96 | 37 | μg/L | 56 | μg/L | 20 | μg/L |
| Dissolved O₂ content | 4.7 | mg/L | 4.7 | mg/L | 4.7 | mg/L |
| pH | 5.8 | | 5.4 | | 5.8 | |

The table and associated figure clearly illustrate the fact that Wustite is capable of removing heavy element contaminants such as arsenic.

A series of experiments utilizing four adsorbent media samples were conducted to illustrate aspects of the invention, using arsenic as the heavy-element contaminant: magnetite (Fe⁺²(Fe⁺³)₂O₄), manganese ferrite (MnFe), 41% Wustite and 60% Wustite. All experiments were conducted in 25 cm long by 0.9 cm diameter stainless steel columns using media samples obtained from PEL Technologies, LLC in Canton, Ohio. The feed solution in all experiments contained 50 μg/L of As(V) in a 15 mM NaCl background electrolyte. Experimental Columns #1 through #12 were operated at a flow rate of 0.5 mL/min, resulting in a mean hydraulic detention time of 10 minutes. Experimental Columns #13 and #14 were conducted at a flow rate of 2.5 mL/min, which resulted in a mean hydraulic detention time of 2 minutes. Oxygen concentrations in the influent water were controlled by purging the water with mixtures of air and/or nitrogen gas. Dissolved oxygen concentrations of 9 mg/L (Experimental Columns #3, #6, #9, ##13-14) were obtained by purging the solution with 100% air. Dissolved oxygen concentrations of 3 mg/L were obtained by purging the solutions with a 33% air and 67% nitrogen mixture (Experimental Columns #2, #5, #8, and #11). Dissolved oxygen concentrations <0.1 mg/L were obtained by purging the solutions with 100% nitrogen gas (Experimental Columns #1, #4, #7 and #10).

TABLE 2
Column Experiments.

| Column | | Dissolved O₂ | Residence |
|---|---|---|---|
| # | Media | (mg/L) | Time (min) |
| 1 | Magnetite | <0.1 | 10 |
| 2 | Magnetite | 3 | 10 |
| 3 | Magnetite | 9 | 10 |
| 4 | MnFe | <0.1 | 10 |
| 5 | MnFe | 3 | 10 |
| 6 | MnFe | 9 | 10 |
| 7 | 41% Wustite | <0.1 | 10 |
| 8 | 41% Wustite | 3 | 10 |
| 9 | 41% Wustite | 9 | 10 |
| 10 | 60% Wustite | <0.1 | 10 |
| 11 | 60% Wustite | 3 | 10 |
| 12 | 60% Wustite | 9 | 10 |
| 13 | MnFe | 9 | 2 |
| 14 | 60% Wustite | 9 | 2 |

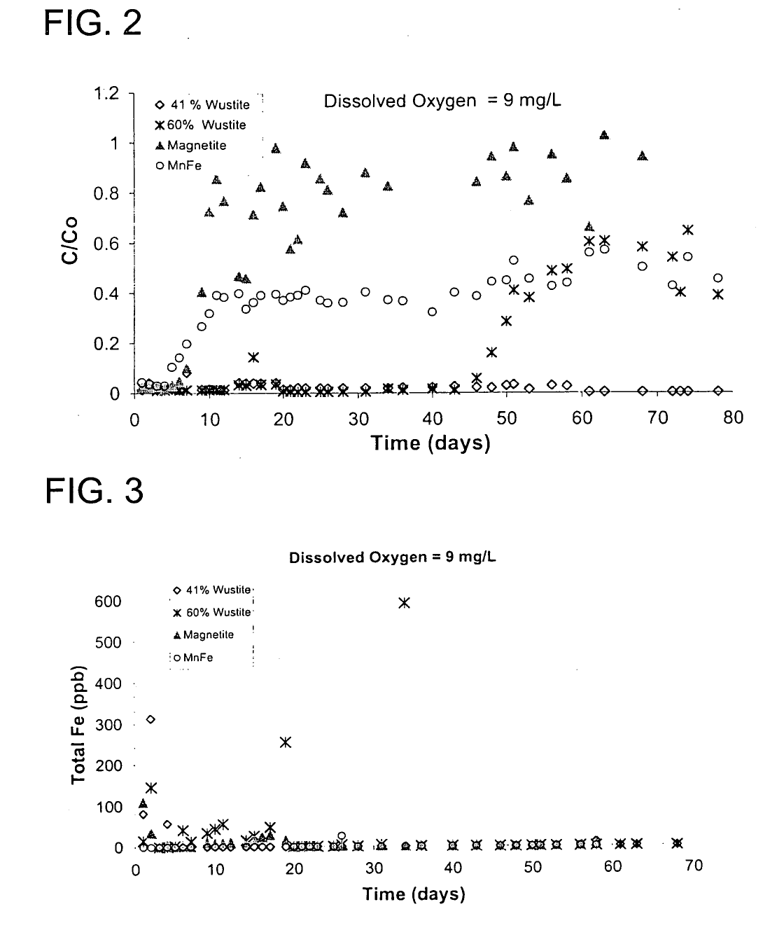

Normalized effluent arsenic concentrations from experimental columns operated with water saturated with dissolved oxygen are shown in FIG. 2. As illustrated in the figure, over the first five days, all media showed nearly complete arsenic removal, which is believed to be attributable to arsenic adsorption to trivalent iron containing oxides present on each media at the commencement of the tests. However, after approximately 5 days, breakthrough was observed on the experimental magnetite and MnFe media samples. It is believed that this breakthrough is attributable to the media corrosion rate being too slow to generate a sufficient number of adsorption sites for complete arsenic removal. For the magnetite particles, the average arsenic removal between 10 and 60 days elapsed was approximately 10% of the feed concentration, which indicates that the corrosion rate of the magnetite was too slow for magnetite to be used in a practical treatment scheme.

For the MnFe media, approximately steady state arsenic removal was achieved between 10 and 45 days elapsed, which indicates that the media was corroding at a steady rate during this period. However, after 45 days elapsed, effluent arsenic concentrations began to gradually increase, which indicates that the corrosion rate of the MnFe particles was slowing down during this period. Moreover, the average effluent manganese concentration from this column was 330 μg/L, which is 11 times greater than the U.S. EPA Recommended Contaminant Level (RCL) for Mn of 30 μg/L, which makes MnFe unsuitable for use in potable water treatment.

For the 60% Wustite media, nearly complete arsenic removal was obtained for 45 days. Breakthrough occurred between 46 and 60 days elapsed, but thereafter, effluent arsenic concentrations appeared to stabilize near 50% of the influent concentration. The breakthrough may be attributed to a slowing down of the media corrosion rate, and/or channeling of the flow through paths that short circuits some of the media. A test also was performed with the 60% Wustite media for a 2 minute retention time. There was near complete arsenic removal for the shorter residence time, which indicates that this media will be effective for arsenic removal in high flow rate systems. For the 41% Wustite media, nearly complete arsenic removal was obtained throughout the duration of the test.

Effluent iron concentrations from the oxygen saturated experiments were taken for each experiment and are shown in FIG. 3. Most samples had iron concentrations that were below the detection limit of 1 μg/L, which is well below the U.S. EPA RCL of 300 μg/L and indicates that leaching of iron from the columns will not be a problem when the PEL media is used.

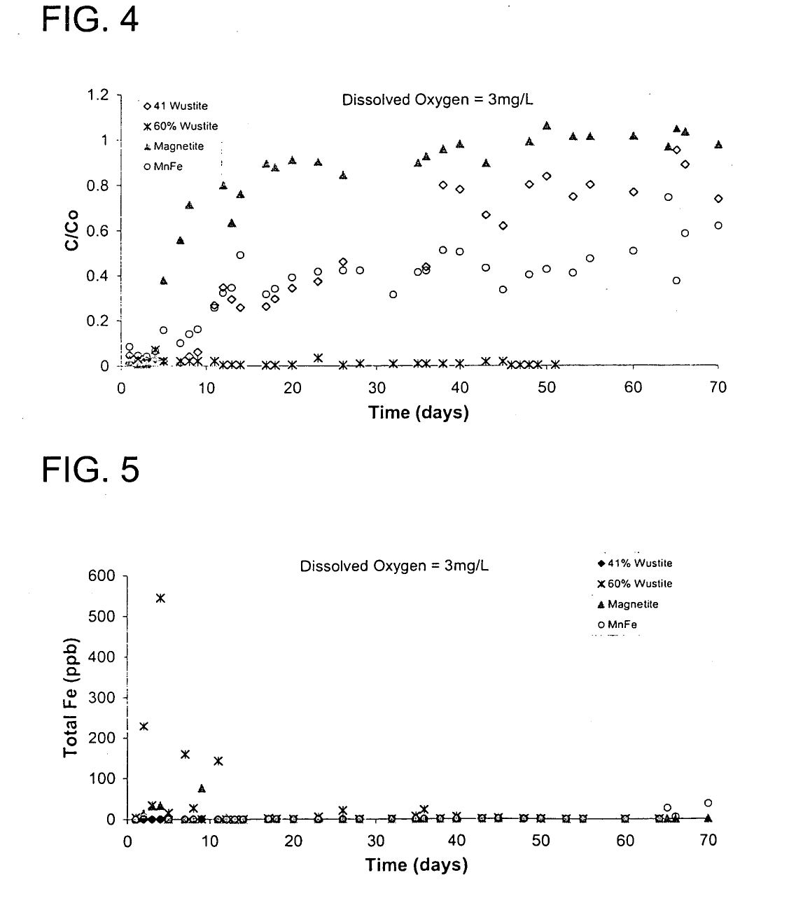

Additional low oxygen experiments were also conducted. Normalized arsenic concentrations for columns operated with feed waters containing 3 mg-O₂/L are shown in FIG. 4. In these experiments, the performance of the magnetite and the MnFe media were similar to their performance for waters with 9 mg-O₂/L. The poor arsenic removal of the magnetite media, and the Mn leaching from the MnFe media make both of these materials unsuitable for water treatment.

The performance of the 60% Wustite media in the low oxygen experiment was similar to that observed for arsenic removal for the oxygen saturated water. However, the performance of the 41% Wustite in the low oxygen experiments was much worse than that observed for arsenic removal in the oxygen saturated water, which implies that the oxidizing potential of water with 3 mg/L dissolved oxygen was not high enough to maintain steady corrosion of the 41% Wustite media.

Effluent iron concentrations from the column with 3 mg-O₂/L are shown in FIG. 5. Most samples were below the detection limit of 1 μg/L for iron, and all but 1 sample were below the U.S. EPA drinking water RCL of 300 μg/L, which again indicates that leaching of iron from the columns will not be a problem when the PEL media is used.

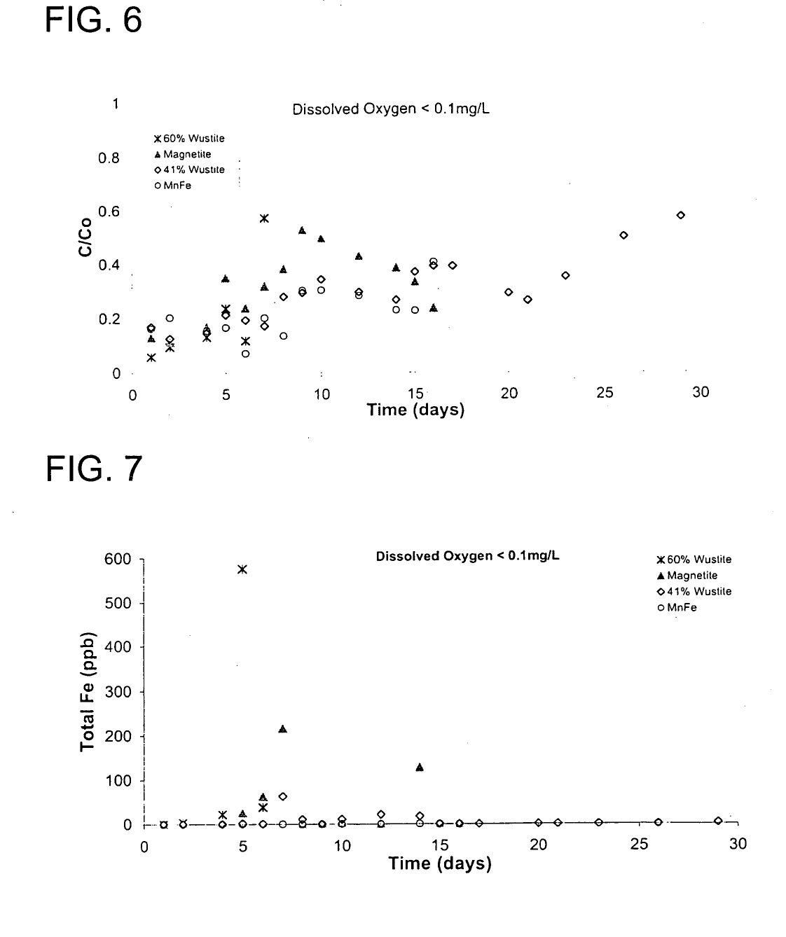

Additional deoxygenated water experiments were also conducted. Normalized effluent arsenic concentrations for columns operated with deoxygenated water are shown in FIG. 6. All columns showed some arsenic removal and all columns clogged by 30 days elapsed. After clogging, the columns were repacked with fresh media and the experiments were repeated. The second set of columns also clogged.

Iron concentrations in the column effluent are shown in FIG. 7. Most samples had iron concentrations below the detection limit. One sample had an iron concentration is excess of the U.S. EPA RCL of 300 μg/L, which was likely due to colloidal iron.

Based on these experiments it is clear that Wustite containing media can be used to maintain near complete heavy element removal over an extended period of time without experiencing the same clogging problem that occurs with other iron-containing materials. Moreover, the effluent water samples contained only trace levels of iron. It is contemplated that the above described experiments and can be replicated on a much larger scale to provide for the efficient removal or heavy elements from heavy elements contaminated water.

As an important feature of the present invention, it is contemplated that heavy element contamination can be removed from oxygen saturated water by passing the contaminated water through a compact bed preferably comprised of between about 20% and about 90% Wustite, and, more preferably, in a range of from approximately 40 to approximately 75% Wustite.

As another important feature of the present invention, it is contemplated that heavy element contamination can be removed from water containing a relatively low level of oxygen, by passing the contaminated water through a compact bed preferably comprised of between about 20% and about 90% Wustite, and more preferably in a range of from approximately 40 to approximately 75% Wustite.

As yet another important feature of the present invention, it is contemplated that heavy element contamination can be removed from deoxygenated water by passing the contaminated water through a compact bed preferably comprised of between about 20% and about 90% Wustite, and more preferably in a range of from approximately 40 to approximately 75% Wustite. In each of the above described embodiments of the present invention, the Wustite adsorbent used in the bed is preferably a non-stoichiometric ferrous oxide expressed as Fe₁₋ₓO, and is in Wustite crystal form, having the rock salt structure with face-centered cubic lattice and known lattice parameters of between about 4.295 to about 4.325 Angstroms measured by XRD. According to the theory of solid chemistry, non-stoichiometric ferrous oxide (i.e. Fe₁₋ₓO) may be regarded as the solid solution of Fe⁺²O and Fe⁺³₂O₃. Therefore, according to wet chemical analysis, the chemical composition of the Wustite used in the present invention are in a range of from about 20 to about 90% by weight of FeO and a range of from about 10 to about 80% by weight of Fe₂O₃, and the ratio of divalent iron to trivalent iron (Fe⁺⁺/Fe⁺⁺⁺) ranges from about 2 to about 20.

The non-stoichiometric ferrous-oxide Wustite used in the present invention, and expressed as Fe₁₋ₓO, is believed to be manufactured by a molten reaction utilized by PEL Technologies, LLC., as illustrated in patents: U.S. Pat. Nos. 5,976,488; 5,370,066; 5,230,292; 5,199,363; 5,127,347; 5,065,680; and 4,960,380.

As yet another important feature of the present invention, the divalent iron oxide particles contained in the bed are capable of generating trivalent iron oxide absorption sites for heavy element removal at a controlled rate that is less than the transition rate of zero-valent iron oxide to trivalent iron oxide.

Thus, it can be seen that the method of adsorbing heavy elements from contaminated water of the present invention increases the amount of heavy elements removed while at the same time increasing the life of the bed. Additionally, the improved bed also reduces or eliminates the problems associated with the heavy element removal beds devices of the prior art including, but not limited to, premature clogging and failure.

Though the present invention is intended for use in removing heavy elements from water, it is also contemplated that the method of the present invention could also be used to remove other heavy elements from other liquids, a non-limiting exemplary list including Se, Ge, Sb, Ga, Cr, Hg, Pb, U, Np, Pu, Am, other actinides, as well as other heavy elements.

Therefore, what has been shown and demonstrated is an adsorbent for heavy elements comprising a main phase wherein said main phase further comprises a non-stoichiometric ferrous oxide which is structurally in a Wustite crystal phase form having the rock salt, face-centered cubic lattice. The said non-stoichiometric ferrous oxide is of the formula Fe₁₋ₓO, wherein x is in a range of from about 0.023 to about 0.14 and a ratio of divalent to trivalent iron ranges from about 2 to about 20. Preferably, the ratio of divalent to trivalent iron ranges from about 3 to about 12. More preferably, the chemical composition of Fe₁₋ₓO comprises a range of from about 56 to about 93% by weight of FeO and a range of from about 7 to about 44% by weight of Fe₂O₃.

Also described is a process for the preparation of the above adsorbent in which the following processing steps are utilized: (a) mixing iron or carbon with magnetic or hematite or combinations thereof to form a mixture; (b) melting the mixture; (c) solidifying the mixture; and (d) crushing the solid.

By following the processes described, the removal of heavy elements from contaminated water is effected using an adsorbent to produce water in which at least one of said heavy elements is decreased in concentration which comprises the step of pass said contaminated water over an adsorbent, said adsorbent comprising a main phase wherein said main phase further comprises a non-stoichiometric ferrous oxide which is structurally in a Wustite crystal phase form having the rock salt, face-centered cubic lattice. While not being bound to theory or any one method of operation, it is believed that when the adsorbent comprises Wustite, having divalent iron oxide particles, at least one of the keys to the invention is related to kinetics, in that the adsorbent is capable of generating trivalent iron oxide absorption sites for heavy element removal at a controlled rate. It is acknowledged that the adsorbent may include both zero valent iron and trivalent iron. In a preferred embodiment, the mixed iron oxide particles will contain at least 20% divalent iron oxide particles. In a more preferred embodiment, there will be at least 40% divalent iron oxide particles. And in a most preferred embodiment, there will be at least 50% divalent iron oxide particles.

Therefore, what has been described is a process for the removal of heavy elements from contaminated water using an adsorbent to produce water in which at least one of said heavy elements is decreased in concentration which comprises the step of pass said contaminated water over an adsorbent, said adsorbent comprising a main phase wherein said main phase further comprises a non-stoichiometric ferrous oxide which is structurally in a Wustite crystal phase form having the rock salt, face-centered cubic lattice wherein said bed is comprised of between about 20 and about 90% Wustite, inclusive.

Phrased alternatively, what has been described is a process of adsorbing heavy elements from contaminated water said method comprising the step of passing the heavy element contaminated water through a bed comprised of divalent iron oxide particles that are capable of generating trivalent iron oxide adsorption sites for heavy elements removal at a controlled rate, the rate of which is less than the transition rate of zero-valent iron oxide to trivalent iron oxide.

Accordingly, the improved method of adsorbing heavy elements from water at the present invention is simplified, and provides an effective, safe, and relatively inexpensive and efficient method which achieves all the enumerated objectives, provides for eliminating or reducing the difficulties encountered with previous heavy element adsorption methods, and solves problems and obtains new results in the art.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the invention is by way of example, and the scope of the invention is not limited to the exact details shown or described.

This invention has been described in detail with reference to specific embodiments thereof, including the respective best modes for carrying out each embodiment. It shall be understood that these illustrations are by way of example and not by way of limitation.

What is claimed is:

1. An adsorbent for heavy elements comprising a main phase wherein said main phase further comprises a non-stoichiometric ferrous oxide at least a portion of which is structurally in a Wustite crystal phase form having the rock salt, face-centered cubic lattice.

2. The adsorbent according to claim 1 wherein the said non-stoichiometric ferrous oxide is of the formula Fe₁₋ₓO, wherein x is in a range of from about 0.023 to about 0.14 and a ratio of divalent to trivalent iron ranges from about 2 to about 20.

3. The adsorbent according to claim 1, wherein the ratio of divalent to trivalent iron ranges from about 3 to about 12.

4. The adsorbent of claim 2 wherein the chemical composition of Fe₁₋ₓO comprises a range of from about 56 to about 93% by weight of FeO and a range of from about 7 to about 44% by weight of Fe₂O₃.

5. A process for the removal of at least one heavy element from contaminated water using an adsorbent to produce water in which at least one of said heavy elements is decreased in concentration which comprises the step of passing said contaminated water over said adsorbent, said adsorbent comprising a main phase wherein said main phase further comprises a non-stoichiometric ferrous oxide at least a portion of which is structurally in a Wustite crystal phase form having the rock salt, face-centered cubic lattice.

6. The process according to claim 5 wherein the said non-stoichiometric ferrous oxide is of the formula Fe₁₋ₓO, wherein x is in a range of from about 0.023 to about 0.14 and a ratio of divalent to trivalent iron ranges from about 2 to about 20.

7. The process according to claim 6, wherein the ratio of divalent to trivalent iron ranges from about 3 to about 12.

8. The process of claim 6 wherein the chemical composition of Fe₁₋ₓO comprises a range of from about 56 to about 93% by weight of FeO and a range of from about 7 to about 44% by weight of Fe₂O₃.

9. The process of claim 5 wherein said adsorbent comprises Wustite, and wherein said Wustite further comprises divalent iron oxide particles that are capable of generating trivalent iron oxide absorption sites for heavy element removal at a controlled rate.

10. The process of claim 9 wherein said adsorbent further comprises zero valent iron and trivalent iron.

11. The process of claim 10 wherein the mixed iron oxide particles further comprise at least 20% divalent iron oxide particles.

12. The process of claim 11 wherein the mixed iron oxide particles further comprise at least 50% divalent iron oxide particles.

13. A process for the removal of at least one heavy element from contaminated water using an adsorbent to produce water in which at least one of said heavy elements is decreased in concentration which comprises the step of passing said contaminated water over said adsorbent, said adsorbent comprising a main phase wherein said main phase further comprises a non-stoichiometric ferrous oxide at least a portion of which is structurally in a Wustite crystal phase form having the rock salt, face-centered cubic lattice wherein said adsorbent is comprised of between 20 and 90% Wustite, inclusive.

14. The process of claim 13 wherein said adsorbent is comprised of at least 40% Wustite.

15. A process of adsorbing at least one heavy element from contaminated water said method comprising the step of passing the heavy element contaminated water through a bed comprised of divalent iron oxide particles that are capable of generating trivalent iron oxide adsorption sites for heavy elements removal at a controlled rate.

16. The process of claim 15 method wherein said controlled rate is less than the transition rate of zero-valent iron oxide to trivalent iron oxide.

17. The process of claim 16 wherein said bed further comprises mixed iron oxide particles.

18. The process of claim 17 wherein said percentage of divalent iron oxide particles in the bed is at least 20%.

19. The process of removing heavy elements from contaminated water of claim 18 wherein said percentage of divalent iron oxide particles in the bed is at least 50%.

20. A process of removing at least one heavy element from contaminated water said method comprising the steps of:
(a) providing a bed comprising mixed iron oxide particles further comprised of at least 20% divalent iron oxide particles wherein said divalent oxide particles are capable of generating trivalent iron oxide particles; and
(b) passing the heavy element contaminated water through the bed.

21. The process of claim 20 wherein said percentage of divalent iron oxide particles is at least 50%.
